(19) United States
(12) Patent Application Publication
(10) Pub. No.: US 2021/0190149 A1
(43) Pub. Date: Jun. 24, 2021

(54) CVT SEPARATOR TOOL

(71) Applicant: Bestop PRP, LLC, Temecula, CA (US)

(72) Inventor: Aaron Wedeking, Temecula, CA (US)

(21) Appl. No.: 16/726,044

(22) Filed: Dec. 23, 2019

(51) Int. Cl. F16D 11/10; F16H 37/08

(52) U.S. Cl. CPC F16D 11/10; F16H 37/0853

(57) ABSTRACT

A clutch includes first and second sheaves, the first sheave including a housing with a slot. A bar is inserted within the slot and a bolt engaged with a threaded opening in the bar and tensioned such that it presses against the second sheave forcing it outwardly against a biasing force. The bar may include two end portions with different widths for two different types of clutches, each end portion including a threaded opening. The clutch may include a slider mounted to the second sheave and positioned with the slot. The bar may include a recess on a bottom surface providing clearance for the slider.

### FIELD OF THE INVENTION

This application relates to tools for working on continuously-variable transmissions (CVT).

### BACKGROUND OF THE INVENTION

Many types of vehicles, machinery and equipment utilize spring compressed pulley sheaves to disengage and engage an engine or motor and to transmit power to final drive assemblies. The flexible belts or chain links connecting the power source to the transmission or drive unit are subject to failure and wear, requiring frequent repair or replacement. Existing levers and other repair tools for working on these assemblies are difficult to use and expose mechanics to risk of injury or damage to property should the tools become dislodged or lose grip on the spring-compressed pulleys being separated.

It would be an advancement in the art to provide improved tools for disassembling spring loaded pulley sheaves.

### SUMMARY OF THE INVENTION

In one aspect of the invention, a method includes providing a clutch including a first sheave mounted to a housing and a second sheave biased into engagement with the first sheave, the housing defining a slot. A bar is inserted into the slot. A bolt is engaged with the bar and is tensioned such that the bolt engages the second sheave and urges the second sheave out of the housing.

The bar has a top surface and a bottom surface and inserting the bar includes inserting the bar having the bottom surface facing the second sheave and the top surface facing a top inner surface of the housing, the top surface engaging the top inner surface of the housing upon tensioning of the bolt.

The clutch may include a slider engaging the second sheave and positioned within the slot. Inserting the bar into the slot may include inserting the bar across the slider. A bottom surface of the bar may define a recess such that the slider is positioned within the slot when the bar is inserted within the slot. The bottom surface of the bar may define planar portions on either side of the recess. An upper edge of the bar around a top surface of the bar opposite the bottom surface may be rounded.

The second sheave may include a portion extending within the housing and secured to the second sheave, the bolt engaging the second sheave by engaging the portion.

The bar may define a threaded opening sized to receive the bolt such that engaging the bolt with the bar comprises threading the bolt into the threaded opening.

In some embodiments, the bar includes a first end portion and a second end portion opposite the first end portion along a longitudinal direction, the second end portion having a different width than the first portion along a horizontal direction perpendicular to the longitudinal direction. Inserting the bar into the slot includes inserting one of the first end portion and the second end portion into the slot. Each of the first end portion and the second end portion may define a threaded opening extending through the bar in a vertical direction perpendicular to the horizontal direction and the longitudinal direction, the threaded openings of the first end portion and the second end portion being sized to receive the bolt. Engaging the bolt with the bar includes threading the bolt into the threaded opening of one of the first end portion and the second end portion. In some embodiments, the bar further defines a curved transition between the first end portion and the second end portion, the curved transition overlapping the recess along the longitudinal direction.

### BRIEF DESCRIPTION OF THE DRAWINGS

Preferred and alternative examples of the present invention are described in detail below with reference to the following drawings:

FIG. 1 is an isometric view of a separator tool in accordance with an embodiment of the present invention;

FIG. 2 is an isometric view of the separator tool with a separator bolt in accordance with an embodiment of the present invention;

FIGS. 3A to 3C are orthogonal views of the separator tool in accordance with an embodiment of the present invention;

FIG. 4 is a side view of the separator tool and bolt in accordance with an embodiment of the present invention;

FIG. 5 is a perspective view of the separator tool in use on a clutch of a CVT in accordance with an embodiment of the present invention; and

FIGS. 6A and 6B are side cross-sectional views of a clutch of a CVT in combination with the separator tool illustrating its method of use in accordance with an embodiment of the present invention.

### DETAILED DESCRIPTION OF THE PREFERRED EMBODIMENT

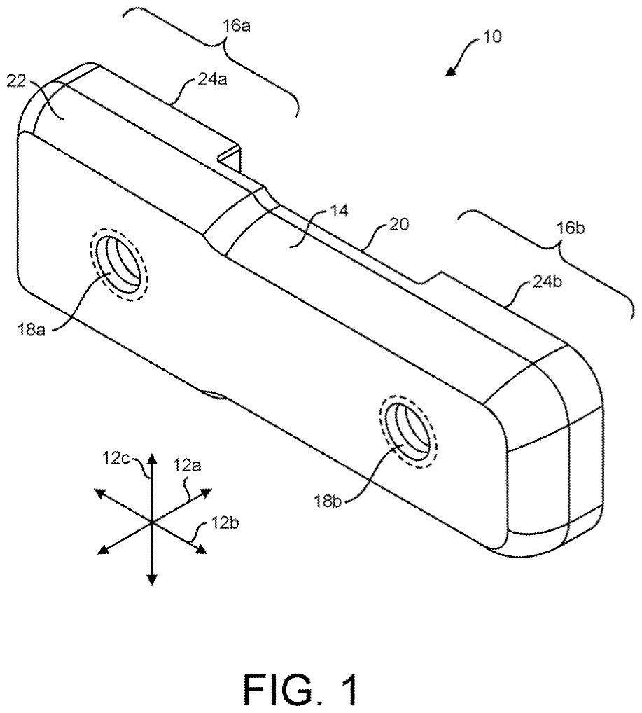

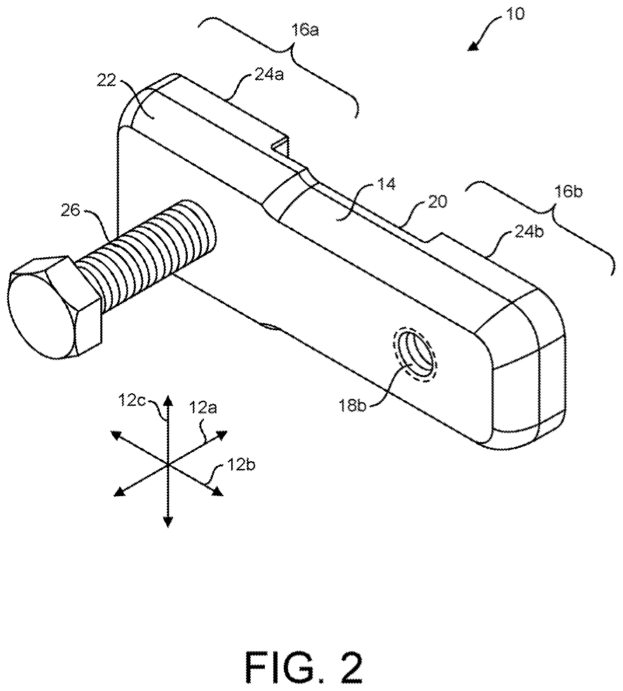

Referring to FIGS. 1 and 2, a clutch removal tool 10 may be understood with respect to a vertical direction 12a, a longitudinal direction 12b, and a horizontal direction 12c, that are all mutually perpendicular. The tool 10 may include a bar 14 having two end portions 16a, 16b that have different widths in the horizontal direction 12c and are on opposite ends of the bar 14 along the longitudinal direction 12a. As discussed below, the end portions 16a, 16b insert within a clutch during disassembly. The different sizes of the end portions 16a, 16b enable the bar 14 to be used with two different types of clutches. The bar 14 may be made of aluminum, steel, composite (carbon fiber, fiberglass, etc.), rigid polymer, or other material having sufficient strength to resist the forces developed during use as described herein.

Each end portion 16a, 16b defines a threaded aperture 18a, 18b having central axes extending through the bar 14 substantially (within 2 degrees of) parallel to the vertical direction 12b. A bottom side of the bar 14 may define a notch 20 or recess 20 that facilitates clearance of components of a clutch during insertion as described below. A top side of the bar 14 may define a chamfered edge 22 that is rounded to provide clearance and to facilitate insertion. The bottom side of the bar 14 further includes portions 24a, 24b on either side of the recess 20. The portions 24a, 24b may be planar and substantially parallel to the longitudinal and horizontal directions 12b, 12c. As shown in FIG. 2, a bolt 26 may be threaded into either of the threaded apertures 18a, 18b and may be threaded through to the extent that the bolt 26 protrudes out of the bottom side of the bar 14.

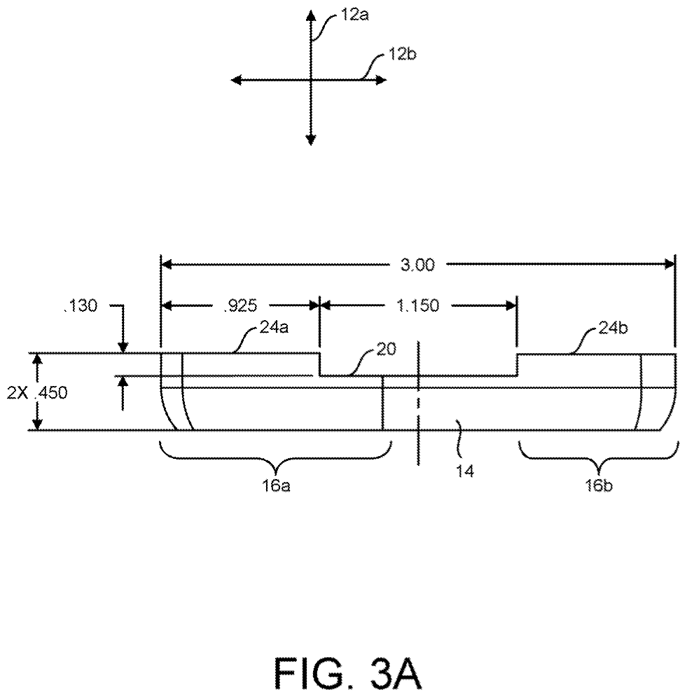

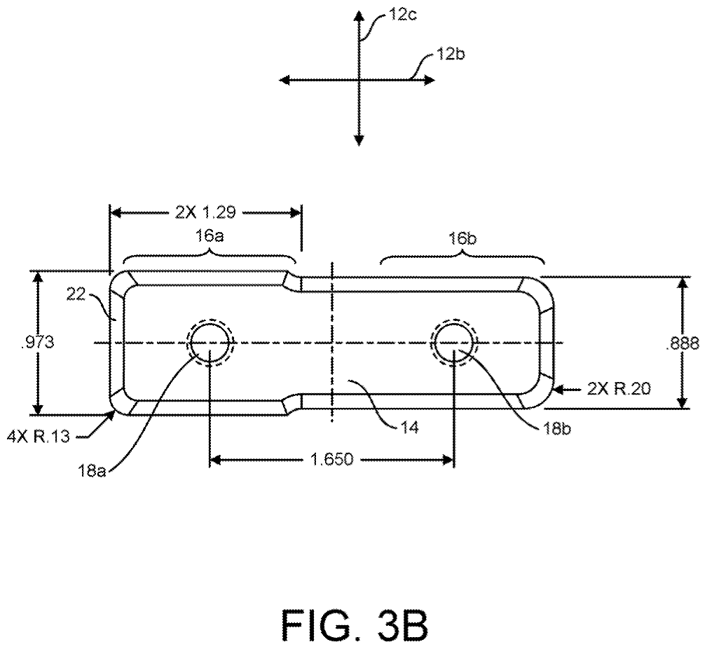

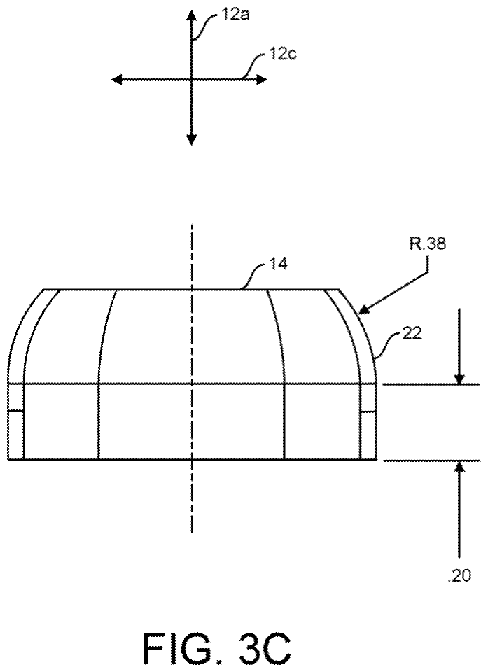

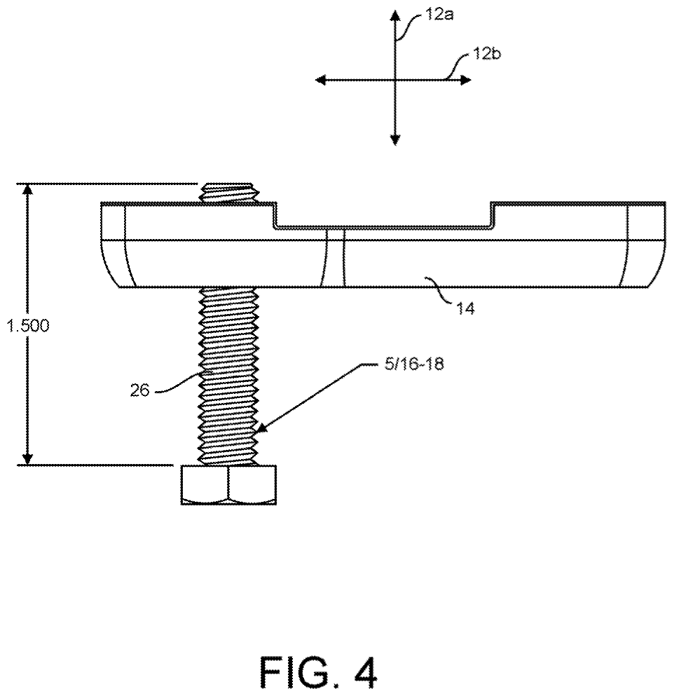

FIGS. 3A, 3B, and 3C illustrate example dimensions of the various features of the bar 14 and FIG. 4 illustrates dimensions of the bolt 26. In FIGS. 3A, 3B, 3C, and FIG. 4, units are in inches. The illustrated dimensions are exemplary only. As is apparent from the dimensions, the bar 14 is longer in the longitudinal direction 12b than in the vertical and horizontal directions 12a, 12c. Both end portions 16a, 16b may be wider in the horizontal direction 12c than they are thick in the vertical direction 12a. As is also apparent, the corners of the bar are rounded in a plane parallel to the longitudinal and horizontal directions 12b, 12c. Likewise, the top edge is rounded around the top surface of the bar 14. The rounding of the top edge may facilitate insertion of the bar during use as discussed below.

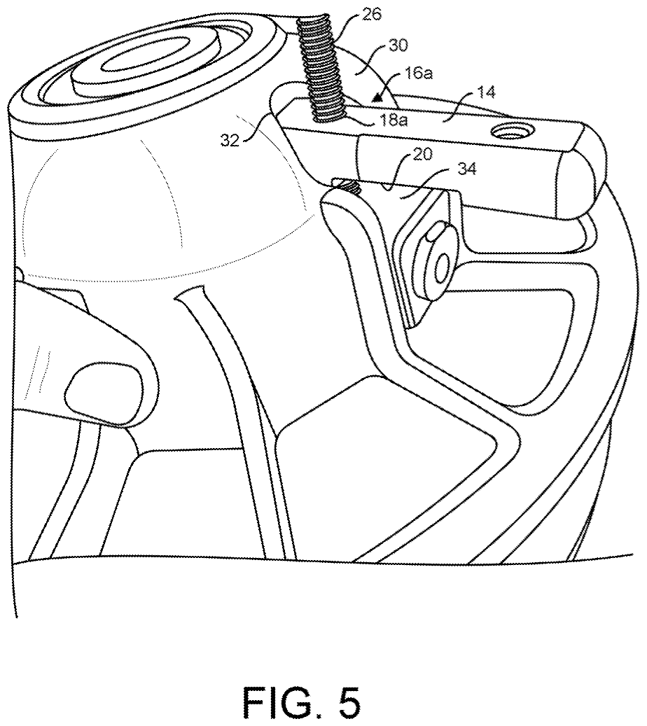

FIG. 5 illustrates a method of use of the tool 10. A housing 30 of a clutch includes a slot 32 through which the end portion 16a is inserted in the illustrated example. For a different design of clutch, the larger end 16b may be used. As is apparent, there is a slider block 34, which may also be a roller in some embodiments, that slides within the slot 32. The recess 20 may be sized such that the end 16a or 16b may be inserted around the slider block 34. Accordingly, the length of the recess 20 along the longitudinal dimension 12b may be selected to be larger than a width of the slider block 34.

FIG. 5 further illustrates operation of the bolt 26. The bolt may be either (a) completely removed during insertion into the slot 32 or (b) inserted into the opening 18a, 18b such that it does not protrude out of the corresponding surface 24a, 24b during insertion. In either case, following insertion, the bolt 26 may be tensioned such that it protrudes out of the surface 24a, 24b and presses against a component of the clutch in order to separate sheaves of a pulley of the clutch.

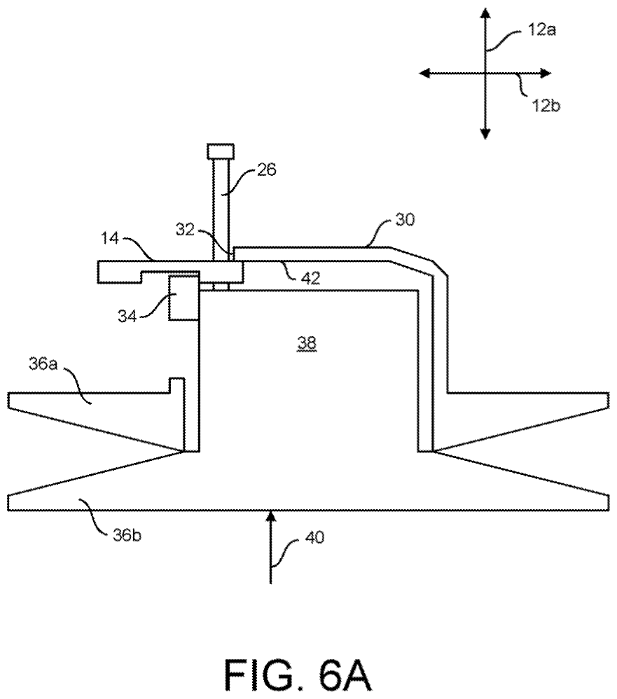

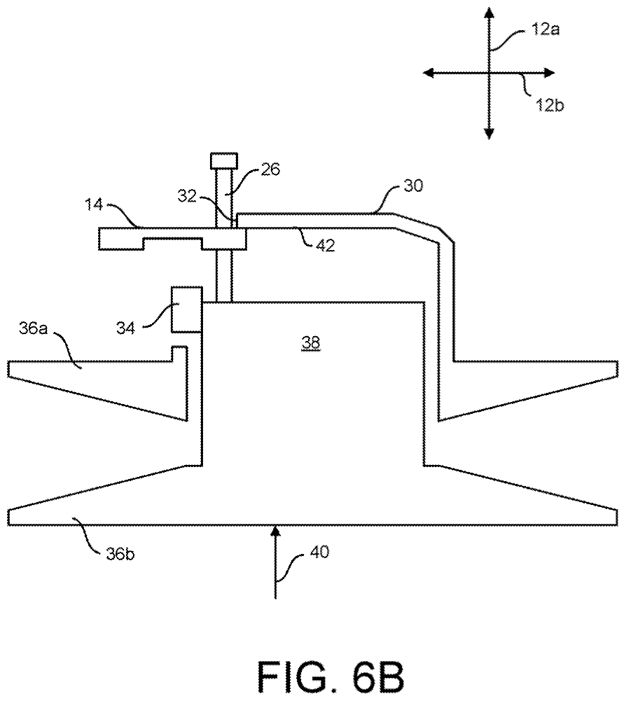

For example, referring to FIG. 6A, the housing 30 has a sheave 36a mounted thereto or formed monolithically therewith. Another sheave 36b is positioned opposite 36b and includes a portion 38 extending into the housing and having the slider 34 mounted thereto. The sheave 36b is subject to a biasing force 40 urging the sheave 36b against the sheave 36a. For example, a spring (not shown) may urge the shave 36b against the sheave 36a. The configuration of the clutch, including parts 36a, 36b, 38, and 40 may be according to any CVT known in the art, particularly those used in snowmobiles, off road utility vehicles, all-terrain vehicles, or other light off-road vehicles.

Following insertion, the bolt 26 is tensioned such that it protrudes out of the bottom of the bar 14. As shown in FIG. 6B, as the bolt 26 is further tensioned, the bolt 26 engages the portion 38 and urges it outwardly from the housing 30. As is apparent in FIGS. 6A and 6B, a portion of the bar 14 (e.g., end portion 16a as shown in FIG. 5) pushes against an upper inner surface 42 of the housing 30 to counter the force exerted by the bolt 26. Removal is the opposite of installation. The bolt 26 is loosened until it no longer engages the portion 38, does not protrude from the bottom of the tool 14, or is completely removed. The bar 14 is then removed from the slot 32.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method comprising:
providing a clutch including a first sheave mounted to a housing and a second sheave biased into engagement with the first sheave, the housing defining a slot;
inserting a bar into the slot; and
engaging a bolt with the bar and tensioning the bolt such that the bolt engages the second sheave and urges the second sheave out of the housing.

2. The method of claim 1, wherein the bar has a top surface and a bottom surface and wherein inserting the bar comprises inserting the bar having the bottom surface facing the second sheave and the top surface facing a top inner surface of the housing, the top surface engaging the top inner surface of the housing upon tensioning of the bolt.

3. The method of claim 1, further comprising a slider engaging the second sheave and positioned within the slot, wherein inserting the bar into the slot comprises inserting the bar across the slider.

4. The method of claim 3, wherein a bottom surface of the bar defines a recess, wherein the slider is positioned within the slot when the bar is inserted within the slot.

5. The method of claim 4, wherein the bottom surface of the bar defines planar portions on either side of the recess.

6. The method of claim 5, wherein an upper edge of the bar around a top surface of the bar opposite the bottom surface is rounded.

7. The method of claim 1, wherein the second sheave includes a portion extending within the housing and secured to the second sheave, the bolt engaging the second sheave by engaging the portion.

8. The method of claim 1, wherein the bar defines a threaded opening sized to receive the bolt, wherein engaging the bolt with the bar comprises threading the bolt into the threaded opening.

9. The method of claim 1, wherein the bar includes a first end portion and a second end portion opposite the first end portion along a longitudinal direction, the second end portion having a different width than the first portion along a horizontal direction perpendicular to the longitudinal direction, wherein inserting the bar into the slot comprises inserting one of the first end portion and the second end portion into the slot.

10. The method of claim 9, wherein each of the first end portion and the second end portion defines a threaded opening extending through the bar in a vertical direction perpendicular to the horizontal direction and the longitudinal direction, the threaded openings of the first end portion and the second end portion being sized to receive the bolt, wherein engaging the bolt with the bar comprises threading the bolt into the threaded opening of one of the first end portion and the second end portion.

11. The method of claim 10, wherein the bar defines a recess on a bottom surface of the bar between the threaded openings of the first end portion and the second end portion, the bar further defining a curved transition between the first end portion and the second end portion, the curved transition overlapping the recess along the longitudinal direction.

12. The method of claim 1, further comprising, de-tensioning the bolt followed by removing the bar from the slot.

13. The method of claim 1, wherein the clutch is part of a continuously variable transmission (CVT).

14. An apparatus comprising:
a bar having a first end portion and a second end portion opposite the first end portion, the second end portion having a different width than the first portion in a horizontal direction;
a first threaded opening defined in the first end portion and extending through the bar in a vertical direction perpendicular to the horizontal direction;
a second threaded opening defined in the first end portion and extending through the bar in the vertical direction; and
a bolt engaged with one of the first threaded opening and the second threaded opening.

15. The apparatus of claim 14, wherein a bottom surface of the bar defines a recess having a recess bottom surface parallel to the horizontal direction and a longitudinal direction perpendicular to the horizontal direction and vertical direction.

16. The apparatus of claim 15, wherein the bottom surface of the bar defines planar portions on either side of the recess, the planar portions being parallel to the horizontal and longitudinal directions.

17. The apparatus of claim 16, wherein an upper edge of the bar around a top surface of the bar opposite the bottom surface is rounded.

18. The apparatus of claim 17, wherein the bar comprises a curved transition between the first end portion and the second end portion, the curved transition overlapping the recess along the longitudinal direction.

19. The apparatus of claim 18, wherein corners of the bar in a plane parallel to the horizontal and longitudinal directions are rounded.

20. The apparatus of claim 14, wherein the bar is aluminum.
